(19) United States
(12) Patent Application Publication
(10) Pub. No.: US 2022/0211085 A1
(43) Pub. Date: Jul. 7, 2022

(54) EDIBLE PASTE AND COMPOSITION AND METHOD OF PREPARATION

(71) Applicant: C-PASTE LIMITED, Dolphinholme Lancashire (GB)

(72) Inventor: STEVEN LAWRENCE, Lancaster Lancashire (GB)

(21) Appl. No.: 17/595,022

(22) PCT Filed: May 1, 2020
(86) PCT No.: PCT/GB2020/051079

§ 371 Date: Nov. 5, 2021

(30) Foreign Application Priority Data
May 7, 2019 (GB) 1906393.2

(51) Int. Cl. A23L 19/10; A23L 29/30; A23L 27/30

(52) U.S. Cl. CPC A23L 19/10; A23V 2002/00; A23L 27/34; A23L 29/37

(57) ABSTRACT

There is provided a method of preparing an edible paste comprising: mixing water; polyol(s), and root vegetable(s), to form a mixture; heating the mixture at a sufficient temperature and for a sufficient period of time to form a paste. The method may be used to provide an edible paste consisting of: from 14 wt % to 92 wt % water; from 6 wt % to 39 wt % polyol(s); from 2 wt % to 30 wt % vegetable derived solids; and from 0 wt % to 20 wt % other edible constituents, wherein the vegetable derived solids:polyol(s) ratio is from 1:1.25 to 1:20. There are also provided mixtures for use in the method, pastes obtainable by the method, uses of the paste in the production of food products, and food products including the paste.

### FIELD

The present disclosure relates to a method of preparing an edible paste and edible pastes obtainable by the method. The paste has utility in the preparation of food products, in particular, low/no sugar and/or low GI foods.

### BACKGROUND

It is known that high sugar and/or high GI foods may be deleterious and/or non-optimal for the health of some people, particularly diabetics. Foods containing sugar alternatives, such as polyol(s), have been previously prepared. However, such foods may be regarded as less attractive than foods containing sugar. Therefore, it is a known desideratum to increase the attractiveness of foods containing sugar alternatives. In particular, if more attractive low/no sugar and/or low GI foods can be prepared, compliance with low sugar and/or low GI diets may be made less burdensome.

Additionally, some people may desire or require no/low gluten, no/low dairy, no/low lactose, and/or vegan foods. This can present a particular problem in that providing such foods, particularly deserts, which are also low sugar/sugar free and/or low GI foods and simultaneously attractive is challenging.

### SUMMARY

There is provided a method of preparing an edible paste comprising mixing water; polyol(s), and vegetable(s), to form a mixture; heating the mixture at a sufficient temperature and for a sufficient period of time to form a paste.

The period of time may be at least 32 minutes.

The temperature may be a temperature sufficient to simmer and/or boil the mixture.

The polyol(s) may comprise or consist of xylitol.

The vegetable(s) may comprise or consist of swede.

The vegetable:polyol ratio of the mixture may be from 1:0.05 to 1:2.

The vegetables may include vegetable derived solids such that the vegetable derived solids:polyol ratio of the mixture is from 1:1.25 to 1:20.

There is also provided an edible mixture, for use in a described method, comprising water; vegetable(s); and polyol(s), wherein the vegetable:polyol ratio is from 1:0.20 to 1:0.9.

There is also provided an edible mixture, for use in a described method, comprising water; vegetables(s) including vegetable derived solids; and polyol(s), wherein the vegetable derived solids:polyol ratio is from 1:1.25 to 1:9.

The edible mixture may be used in a described method to form edible paste.

There is also provided a paste obtainable by a described method and/or use.

There is also provided an edible paste consisting of from 14 wt % to 92 wt % water; from 6 wt % to 39 wt % polyol(s); from 2 wt % to 30 wt % vegetable derived solids; and from 0 wt % to 20 wt % other edible constituents, wherein the vegetable derived solids:polyol(s) ratio is from 1:1.25 to 1:20.

The paste may be homogeneous.

The polyol(s) may comprise or consist of xylitol.

The vegetable derived solids may comprise or consist of swede derived solids.

The other edible constituents may be present in an amount of from 0 wt % to 4 wt %. The other edible constituents may be present in an amount of from 0 wt % to 1 wt %.

The paste may comprise 7 wt % or less sugars.

There is also provided an edible composition consisting of: from 7 wt % to 50 wt % water; from 12 wt % to 67 wt % polyol(s); from 4 wt % to 52 wt % vegetable derived solids; and from 0 wt % to 40 wt % other edible constituents, wherein the vegetable derived solids:polyol(s) ratio is from 1:1.25 to 1:20.

The polyol(s) may comprise or consist of xylitol.

The vegetable derived solids may comprise or consist of swede derived solids.

The other edible constituents of the composition may be present in an amount of from 0 wt % to 8 wt %, or in an amount of from 0 wt % to 2 wt %.

The paste may be used as a sugar substitute.

The paste may be used in the production of a food product.

There is also provided a food product including a described paste.

### DESCRIPTION OF EMBODIMENTS

Embodiments will now be described by way of example only.

There is provided a method of preparing an edible paste comprising: mixing water; polyol(s), and root vegetable(s), to form a mixture; heating the mixture at a sufficient temperature and for a sufficient period of time to form a paste. The method may be used to provide an edible paste consisting of: from 14 wt % to 92 wt % water; from 6 wt % to 39 wt % polyol(s); from 2 wt % to 30 wt % vegetable derived solids; and from 0 wt % to 20 wt % other edible constituents, wherein the vegetable derived solids:polyol(s) ratio is from 1:1.25 to 1:20. There are also provided mixtures for use in the method, pastes obtainable by the method, uses of the paste in the production of food products, and food products including the paste.

### Methods

Whilst it is known to sweeten foods with polyols and that this may be advantageous for diabetics, for those on carbohydrate controlled diets, and for those desiring to reduce glucose spikes, for example, the organoleptic properties of such foods may be regarded as inferior to those sweetened in other ways. Other advantages of the use of polyols in the preparation of food products are also known, for example, polyols are not acted upon by bacteria in the mouth and therefore do not cause tooth decay (unlike sugars). Therefore, it is a non-exclusive aim of the present disclosure to prepare foods having advantages of the use of polyols which are more attractive to consumers.

It is a realisation of the present disclosure that the manner in which polyols are incorporated into foods, particularly deserts, as sweeteners can affect the quality of the food in which they are incorporated. For example, uneven distribution of polyol within foods can result in uneven sweetness, which in turn can result in uneven texture, which may be experienced as a granular taste.

Accordingly, the present disclosure provides a method of preparing an edible paste comprising mixing water; polyol(s), and vegetable(s), to form a mixture; heating the mixture at a sufficient temperature and for a sufficient period of time to form a paste.

The paste so obtained has been found to be useable as the equivalent of a confectioner's paste. The paste can be readily used in the preparation of a wide variety of food products, for example, cakes, chocolate tortes, ice creams, and hazelnut coca spreads (similar to that sold under the NUTELLA™ brand). Such food products have been judged to be more attractive that those prepared by known methods, for example, by direct incorporation of polyols into recipes for cakes, chocolate tortes, ice creams, hazelnut coca spreads, etc. By “more attractive food products” it is meant that the food products have more desirable organoleptic properties (e.g. at least one of taste, smell, appearance, texture). Without wishing to be bound by theory, it is thought that by incorporating the polyol into the paste a more even distribution of the polyol throughout the food is achieved and that in turn this results in the more attractive food products. Additionally, without wishing to be bound by theory, it is thought that replacing (some of) the sugar of conventional recipes with the paste is superior to replacing sugar of conventional recipes with a polyol alone, as the vegetable derived solids increase the mass of the paste; in this way, not only the sweetness, but also the mass of sugar can be substituted using the paste described herein.

As will be appreciated, the paste may be more effective than other sweeteners used to replace sugar (including honey, maple syrup and rice malt syrup) as the paste may be used to replace sugar mass as well as sugar sweetness. In turn, this may require minimal changes to other ingredients used and cooking times. Replacing sugar with the described pastes can reduce the sugar content of a food product between 40% and 80% in excising recipes and by 100% in recipes created around the paste.

Additionally, the polyol may increase and intensify the natural sweetness of the vegetables.

Further, the paste may be prepared using principally or only water, polyol(s), and vegetable(s). This is regarded as superior to highly artificial foods containing quantities of artificial ingredients, which may be generally regarded as undesirable by consumers. Accordingly, the paste may be prepared cost effectively. The paste may be viewed as a particularly cost effective replacement for sugar. In particular, the paste can be used to replace both the sweetness and the mass of sugar for lower prices than prior sugar replacements.

The paste (and its use) may also be considered to have environmental benefits (or low environmental costs), as the mixtures used to prepare the paste may be sourced locally, since they are commonly available. Accordingly, use of the described paste to replace/reduce prior ingredients (e.g. sugars and oils) in food production may reduce carbon food miles.

Yet further, the paste may be used as an egg and sugar substitute in the preparation of foods, as the paste as well as providing sweetness can also provide moisture in a form which is evenly distributed throughout a food into which it is incorporated. Accordingly, the paste may be used in the provision of vegan foods, e.g. vegan deserts.

Yet further, the paste may be used as a sugar, egg, and/or fat (including oil) replacement.

Yet further, the paste may be used in the provision of low gluten/gluten free food products. Yet further, the paste may be used in the provision of no dairy/low dairy food products.

Yet further, the paste may be used in the provision of no lactose/low lactose food products. For example, the paste may be used as a milk and sugar substitute in the preparation of foods. In particular, as well as providing sweetness the paste can also provide moisture in a form which is evenly distributed throughout a food into which it is incorporated.

It is therefore apparent that the present method and paste can facilitate the production of attractive low sugar and/or low GI foods, which may also be low gluten/gluten free, low dairy/dairy free, low lactose/lactose free, and/or vegan. In particular, the present method and paste can facilitate the production of such foods which are also deserts, for example, cakes, chocolate tortes, ice creams, hazelnut coca spreads, etc., as will be described in more detail below.

As part of the described method the mixture is heated at a sufficient temperature and for a sufficient period of time to form a paste. The temperature and time required to form a paste will depend upon on a number of factors. For example, a mixture heated at a low simmer would usually require a longer period of time to form a paste than a mixture at a rolling boil. Different vegetables may also require differing temperatures and/or periods of time. Different polyols may again affect the required temperatures and/or periods of time. Further, the ratio of the water, polyol(s) and vegetable(s) used may affect the required temperatures and/or period combinations. Other factors may also affect the required temperatures and/or periods, for example, if the method is performed in a pot with a lid a longer period of time or a greater temperature may be required in order to form a paste because water evaporation may be slower (or alternatively water condensation on the lid of a pot may require greater temperatures and or periods of time). Obversely, if the method is performed in a pot without a lid a shorter period of time or a lower temperature may be required in order to form a paste because water evaporation may be quicker.

The period of time may be at least 32 minutes. Alternatively, the period of time may be at least 35, 40, 50, 60, 70, 80, 90, 100, 110, 120, 130, 140, 150, 160, 170, 180, 190, or 200 minutes. Use of longer periods (cooking times) has been found to favour the formation of a paste. Specifically, longer periods cause the vegetable(s) to break down and a paste to be formed. At shorter cooking times a paste may not be formed, for example, discrete pieces of vegetables may still be present within the mixture.

The temperature may be a temperature sufficient to simmer and/or boil the mixture. For example, the temperature may be a temperature sufficient to bring the mixture to a slow boil. Use of such temperatures has been found to favour the formation of a paste. Specifically, use of such temperatures causes the vegetable(s) to break down and a paste to be formed. At lower temperatures a paste may not be formed, for example, discrete pieces of vegetables may still be present within the mixture.

It will be apparent that the temperature and period required to form a paste varies dependent upon a number of factors. Indeed, the temperature required is dependent upon the period used and the period required is dependent upon the temperature used.

Further, it will be apparent that the temperature may not be constant throughout the period, for example, the mixture may initially be at room temperature, then the mixture may be heated to boiling with a lid on, then held at boiling with the lid on, the lid may then be removed, and then the mixture subsequently simmered. Of course, numerous variations are possible, for example, the mixture may initially be at room temperature, then heated to boiling with a lid on, the lid may then be removed, then the mixture may be held at boiling without a lid, and then the mixture subsequently simmered still without a lid. Such variations will affect the length of the period required.

Further, it will also be apparent that the period may not be continuous. For example, the mixture may initially be heated, then allowed to cool, and then heated again. However, a single continuous period (with constant or varying temperatures) may result in a simpler method.

The temperature and period of time required to form a paste will usually be determined by heating a mixture and observing the mixture until such a time as a paste is formed. The temperatures and periods required can be determined using the normal skills of a chef, for example, if a paste is not formed and the temperature is low, e.g. below a simmer, then the temperature would be increased for a period.

When used herein the term “paste” has its normal meaning within the food arts, specifically, a moist but fairly stiff mixture.

The pastes formed by the method may be homogeneous. When used herein the term “homogeneous” has its normal meaning within the food arts, specifically, having a single phase of uniform texture, nature or character throughout. Accordingly, a mixture of shredded vegetables and water would not be considered homogenous as it is biphasic. However, a single phase containing, for example, vanilla seeds as flavouring (which will be described in more detail below), would be considered homogenous as vanilla seeds are sufficiently tiny such that a paste containing vanilla seeds has a uniform texture, nature and character throughout.

The pastes formed by the method may, additionally or alternatively, be described as monophasic.

Including a homogeneous or monophasic paste in food products enables the production of food products which have an even sweetness and/or texture to them, which may be perceived as superior by consumers of the food products.

To date pastes have been prepared using the methods on a kitchen scale. Commercial production of the pastes is thought to be possible using existing food manufacturing technology, accordingly it is hoped that the pastes can be produced commercially on a large scale at a cost that is significantly lower than existing alternative sweeteners. With large scale production, it is thought possible to produce the pastes at a cost where they could be supplied commercially at a price point close to the cost of commercial sugar. This is especially apparent alongside the potential nutritional and environmental benefits of the pastes described herein.

### Polyols

A variety of polyols may be used in the present method and accordingly included in the described pastes. Polyols may also be called sugar alcohols (although they are not sugars or alcohols). Polyols may be considered to be modified forms of carbohydrates. They are incompletely absorbed and metabolized but the body and consequently contribute less calories to the human diet than most sugars.

The calorie count of polys ranges from 0 to 3 calories per gram compared to 4 calories per gram for some sugars. Accordingly, as they have a sweet taste, they can be used to provide lower calorie sweet foods, as is known per se.

Example Polyols (Sugar Alcohols) include:

monosaccharide-derived sugar alcohols (e.g., sorbitol, mannitol, xylitol, erythritol, arabinose);

disaccharide-derived sugar alcohols (e.g., isomalt, lactitol, maltitol);

polysaccharide-derived sugar alcohol mixtures (e.g., maltitol syrup, hydrogenated starch hydrolysates [HSH]); and

glycerol and lactitol.

Xylitol may be a preferred polyol as it is considered to have approximately the same sweetness as sucrose, whilst only having 2.4 calories per gram.

As detailed below, polyols which have been used in past examples include xylitol.

Erythritol may also be a preferred polyol as it is considered to have 60 to 80% of the sweetness as sucrose, whilst only having 0 to 0.2 calories per gram (with the variance in calories per gram being determined by differing measurement authorities, for example the FDA classes erythritol as having 0.2 kcal/g and the EU classes erythritol as having 0 kcal/g, with the difference mainly arising from the understood uptake in the gut).

Mixtures of polyols may be employed, for example, in order to achieve a balance of effects of individual polyols. Alternatively, a single polyol may be used.

Although polyols are used in the described methods, the described pastes may contain polyol derived solids/compounds in addition to or alternative to polyols per se. For example, without wishing to be bound by theory the polyols may react with the vegetables during the heating period.

### Vegetables

A wide variety of vegetables may be used in the described method and included in the described paste.

As used in this specification “vegetable” has the normal culinary meaning and includes all vegetables sub-groups. As is known, vegetables come from many different parts of plants, including the leaves, roots, tubers, flowers, stems, seeds and shoots. Legumes are the seeds of the plant and may be eaten in their immature form as green peas and beans, or in their mature form as dried peas, beans, lentils and chickpeas.

Example Vegetables Include:

dark green or cruciferous/brassica (including broccoli, brussels sprouts, bok choy, cabbages, cauliflower, kale Lettuce, silverbeet, spinach, snow peas);

root/tubular/bulb vegetables (including potato, cassava, sweet potato, taro, carrots, beetroot, onions, shallots, garlic, bamboo shoots, swede, turnip);

legumes/beans (including red kidney beans, soybeans, lima beans, cannellini beans, chickpeas, lentils, split peas, tofu); and

other vegetables (including tomato, celery, sprouts, zucchini, squash, avocado, capsicum, eggplant, mushrooms, cucumber, okra, pumpkin, green peas, green beans).

As detailed below, vegetables which have been used in past examples include swedes, carrots, turnips, and parsnips.

The vegetable(s) may comprise or consist of swede. Swede is also known as rutabaga. Use of a swede has been found to be preferred for use in producing some foods, as when a swede is used the resultant paste has a taste dominated by the polyol and an off-white colour. In other words, the paste produced has a neutral flavour that blends well with other tastes. Further, as the resultant paste has an off-white colour it can be used in the production of, for example, white sponge cakes having a similar appearance to the sugar containing equivalents to which they are analogous. Accordingly, the paste has wide applicability in the production of food products. Such a result is not necessarily possible if intensely coloured or flavoured vegetable is used, as the resultant paste may colour or flavour the food products in which it is incorporated in an undesirable way. Additionally, the swede itself has a low sugar content (even lower than some other vegetables), which in turn provides a paste having a low sugar content.

The vegetable(s) may comprise or consist of carrots. Although carrots have a more intense colour than swedes, many of the advantages of the disclosed paste have been realised using carrots.

The vegetable(s) may comprise or consist of parsnips. Parsnips have greater sugar content and GI than swedes. Consequently, the paste prepared using parsnips may be sweeter in taste, whilst still having a neutral colour.

The vegetable(s) may comprise or consist of turnips.

The vegetable(s) may comprise or consist of parsnips.

The vegetable(s) may be other root vegetables.

The vegetable(s) included in the mixture may be processed vegetable(s) (e.g. cooked, pickled, dried, powdered, frozen, pureed, juiced, etc.) or unprocessed vegetable(s) (e.g. uncooked, not pickled, not dried, not powdered, not frozen, not pureed, not juiced, etc.).

It may be advantageous to peel and/or chop the vegetable before it is included in the mixture to form the paste. Peeling the vegetable means that skins, which may lend an undesirable texture to the paste, are not included in the paste. Chopping the vegetable can help to reduce the temperature and/or period of the method which is required to form a paste.

The choice of vegetable will depend upon the desired qualities of the paste produced. For example, beetroot has an intense colour and taste which will be present in any paste made from a mixture including beetroot. As another example, it may be desirable for the paste to have a relatively low starch content, in which case using exclusively potatoes, which have a relatively high starch content, would not be preferred.

Vegetables which are expected to be advantageously used in the described method include: chickpeas, (garbanzos, or ceci beans); lima beans or butter bean; a selection of root vegetables, including carrot, parsnip, swede (neeps or rutabaga), turnip; a selection of squashes, including acorn squash, butternut squash, banana squash, delicate, patty pans, pumpkin.

Vegetables which may be advantageously used in the described method include: aubergine (eggplant); legumes, including azuki beans (or adzuki), black beans, black-eyed peas, borlotti bean, broad beans, kidney beans, lentils, mung beans, navy beans, pinto beans, split peas, soy beans, peas, mangetout or snap peas; broccoli stem; cauliflower; rhubarb; root vegetables including beetroot, mangel-wurzel, celeriac, daikon (Mouli); salsify (Oyster Plant), sweetcorn, jerusalem artichokes, topinambur; zucchini (courgette); a selection of squashes, including gem squash, hubbard squash, marrow, spaghetti squash;

tubers including jicama, jerusalem artichoke, potato, quandong, sunchokes, sweet potato, taro, yam.

Other vegetables which may be tired in the described method include: globe artichoke; amrud; asparagus; legumes, including alfalfa sprouts, bean sprouts, green beans, French beans, runner beans; broccoli (calabrese); brussels sprouts; cabbage; kohlrabi; celery; endive; fiddleheads; frisee; fennel; greens, including beet greens (chard), bok choy, chard (beet greens), collard greens, kale, mustard greens, spinach, quinoa; herbs, including anise, basil, caraway, cilantro (also known as coriander), chamomile, dill, fennel, lavender, lemon grass, marjoram, oregano, parsley, rosemary, sage, thyme; lettuce; arugula; mushroom; nettles; spinach; okra; onions, including chives, garlic, leek, onion, shallot, scallion (spring onion); parsley; peppers, including bell pepper, chili pepper, Jalapeno, Habanero, Paprika, Tabasco pepper, Cayenne pepper; radicchio; root vegetables, including ginger and radish, including wasabi, horseradish, white radish; skirret; squashes, including cucumber; tat soi; tomatoes; water chestnut; watercress; cucumber.

### Flavourings

The method may include adding a flavouring to the mixture. Additionally or alternatively, the method may include adding a flavouring to the paste.

With some flavourings it may be advantageous to add a flavouring agent (e.g. vanilla pod, cinnamon stick) to the mixture. After heating the mixture to form a paste the flavouring agent (e.g. vanilla pod, cinnamon stick) may be removed. As will be apparent, although the flavouring agent may be removed, the paste may be flavoured by material cooked into the paste (e.g. vanilla seeds, aromatic cinnamon compounds).

In particular, the method may include adding (cut) fresh vanilla pod(s) to the mixture. After heating the mixture to form a paste, the vanilla pod may be removed. After removal of the vanilla pod, vanilla seeds may remain in the paste.

Whilst not required, adding a flavouring to the mixture and hence to the paste, can result in a tastier, more desirable paste.

Alternative flavourings to vanilla pods may also be used. In particular, vanilla extract, vanilla essence, and/or vanilla paste may additionally or alternatively be added to the mixture or the paste. Further examples include: adding cinnamon stick(s) to the mixture and then removing the sticks after the heating the mixture to form a paste; adding honey to the mixture or to the paste; adding citrus flavourings, e.g. adding citrus juice (e.g. orange, lemon, lime) to the mixture or to the paste, and/or adding citrus zest to the mixture; and/or adding cinnamon powder to the mixture. Combinations of the described flavourings may be used and alternative flavourings may be used in addition to or as alternatives to the described flavourings.

### Mixtures

There is also provided an edible mixture, for use in a described method, comprising water;

vegetable(s); and polyol(s).

The vegetable:polyol ratio may be from 1:0.05 to 1:2.

The vegetable:polyol ratio may be at most 1:X, wherein X is 1.8; 1.6; 1.4; 1.2; 1.0; 0.8; 0.6; 0.5; 0.45; 0.40; 0.35; 0.30; 0.25; or 0.20.

The vegetable:polyol ratio may be 1:0.20; 1:0.2; about 1:0.20; or about 1:0.2.

The vegetable:polyol ratio may be at least 1:Y, wherein Y is 0.06; 0.07; 0.08; 0.09; 0.10; 0.11; 0.12; 0.13; 0.14; 0.15; 0.16; 0.17; 0.18; 0.19; or 0.20.

The vegetable derived solids:polyol ratio of the mixture may be from 1:0.5 to 1:20; from 1:1.25 to 1:20; from 1:1 to 1:3; and/or from 1:1.5 to 1:2.5.

By “vegetable derived solids” it is meant the mass of vegetables excluding water contained with the vegetables. Therefore, for example, if 1.0 kg of swedes and 200 g of xylitol are included in a mixture, the swedes used are known to be 90 wt % water (which can be readily determined by routine nutritional analysis or by look up in known data tables), the mixture includes 100 g of swede (vegetable) derived solids and, therefore, the ratio of vegetable derived solids:polyol of the mixture would be 1:2.0.

The vegetable derived solids:polyol ratio may be at least 1:A, wherein A is 0.6; 0.7; 0.8; 0.9; 1.0; 1.1; 1.2; 1.3; 1.4; 1.5; 1.6; 1.7; 1.8; 1.9; or 2.0.

The vegetable derived solids:polyol ratio may be 1:2.0; 1:2; about 1:2.0; or about 1:2.

The vegetable derived solids:polyol ratio may be at most 1:B, wherein B is 20; 19; 18; 17; 16; 15; 14; 13; 12; 11; 10; 9; 8; 7; 6; 5; 4; 3; 2.8; 2.6; 2.4; 2.3; 2.2; 2.1; or 2.0.

The mixture may consist of: from 20 wt % to 65 wt % water; from 20 wt % to 75 wt % vegetable(s); from 3 wt % to 15 wt % polyol(s); and from 0 wt % to 20 wt % other edible constituents.

The water may be present in an amount of at least 22 wt %; 24 wt %; 26 wt %; 28 wt %; 30 wt %; 32 wt %; 34 wt %; 36 wt %; 38 wt %; 40 wt %; 42 wt %; 44 wt %; 46 wt %; 48 wt %; 50 wt %; 52 wt %; 54 wt %; 56 wt %; or 58 wt %.

The water may be present in an amount of at most 64 wt %; 62 wt %; 60 wt %; 58 wt %; 56 wt %; 54 wt %; 52 wt %; 50 wt %; 48 wt %; 46 wt %; 44 wt %; 42 wt %; 40 wt %; 38 wt %; 36 wt %; 34 wt %; 32 wt %; 30 wt %; 28 wt %.

In particular, the water may be present in an amount of from 25 wt % to 60 wt %.

The vegetables may be present in an amount of at least 20 wt %; 22 wt %; 24 wt %; 26 wt %; 28 wt %; 30 wt %; 32 wt %; 34 wt %; 36 wt %; 38 wt %; 40 wt %; 42 wt %; 44 wt %; 46 wt %; 48 wt %; 50 wt %; 52 wt %; 54 wt %; 56 wt %; 58 wt %; or 60 wt %.

The vegetables may be present in an amount of at most 74 wt %; 72 wt %; 70 wt %; 68 wt %; 66 wt %; 64 wt %; 62 wt %; 60 wt %; 58 wt %; 56 wt %; 54 wt %; 52 wt %; 50 wt %; 48 wt %; 46 wt %; 44 wt %; 42 wt %; 40 wt %; 38 wt %; or 36 wt %.

In particular the vegetables may be present in an amount of from 40 wt % to 60 wt %.

The vegetable derived solids may be present in an amount of at least 2.0 wt %; 2.2 wt %; 2.4 wt %; 2.6 wt %; 2.8 wt %; 3.0 wt %; 3.2 wt %; 3.4 wt %; 3.6 wt %; 3.8 wt %; 4.0 wt %; 4.2 wt %; 4.4 wt %; 4.6 wt %; 4.8 wt %; 5.0 wt %; 5.2 wt %; 5.4 wt %; 5.6 wt %; 5.8 wt %; or 6.0 wt %.

The vegetables may be present in an amount of at most 7.4 wt %; 7.2 wt %; 7.0 wt %; 6.8 wt %; 6.6 wt %; 6.4 wt %; 6.2 wt %; 6.0 wt %; 5.8 wt %; 5.6 wt %; 5.4 wt %; 5.2 wt %; 5.0 wt %; 4.8 wt %; 4.6 wt %; 4.4 wt %; 4.2 wt %; 4.0 wt %; 3.8 wt %; or 3.6 wt %.

In particular the vegetable derived solids may be present in an amount of from 4.0 wt % to 6.0 wt %.

The polyols may be present in an amount of at least 3 wt %; 4 wt %; 5 wt %; 6 wt %; 7 wt %; 8 wt %; 9 wt %; 10 wt %; 11 wt %; or 12 wt %.

The polyols may be present in an amount of at most 15 wt %; 14 wt %; 13 wt %; 12 wt %; 11 wt %; 10 wt %; or 9 wt %.

In particular, the polyol(s) may be present in an amount of from 9 wt % to 12 wt %.

Other edible constituents may be present in an amount of at most 20 wt; 15 wt %; 10 wt %; 9 wt %; 8 wt %; 7 wt %; 6 wt %; 5 wt %; 4 wt %; 3 wt %; 2 wt %; 1 wt %; 0.5 wt %; present in only trace amounts or not present.

In particular, the mixture may consist of: from 28 wt % to 46 wt % water; from 35 wt % to 60 wt % vegetable(s); from 9 wt % to 12 wt % polyol(s); and from 0 wt % to 5 wt % other edible constituents.

The present disclosure also provides exemplary mixtures for use in the described method. It will be appreciated that other described mixtures alternative to novel exemplary mixtures may also be used in the method to advantage.

As will be apparent, since the exemplary mixtures may be used in the described methods any of the features of the exemplary mixtures may be employed in the described methods.

Accordingly, there is also provided an edible mixture, for use in a described method, comprising water; vegetable(s); and polyol(s), wherein the vegetable:polyol ratio is from 1:0.20 to 1:0.9.

The vegetable:polyol ratio may be at most 1:X, wherein X is 0.9; 0.8; 0.7; 0.6; 0.5; 0.4; 0.35; 0.3; 0.30; or 0.25.

The vegetable:polyol ratio may be 1:0.20; 1:0.2; about 1:0.20; or about 1:0.2.

The vegetable:polyol ratio may be at least 1:Y, wherein Y is 0.20; 0.25; 0.30; 0.3; 0.4; 0.5; 0.6; 0.7; or 0.8.

There is also provided an edible mixture, for use in a described method, comprising water; vegetables(s) including vegetable derived solids; and polyol(s), wherein the vegetable derived solids:polyol ratio is from 1:1.25 to 1:9.

The vegetable derived solids:polyol ratio may be at least 1:A, wherein A is 1.25; 1.30; 1.35; 1.40; 1.45; 1.50; 1.55; 1.60; 1.65; 1.70; 1.75; 1.80; 1.85; 1.90; 1.95; 2.0; 2.1; 2.2; 2.3; 2.4; 2.5; 2.6; 2.7; 2.8; 2.9; 3.0; 3.5; 4.0; 4.5; 5.0; 5.5; 6.0; 6.5; 7.0; 8.0; or 9.

The vegetable derived solids:polyol ratio may be 1:2.0; 1:2; about 1:2.0; or about 1:2.

The vegetable derived solids:polyol ratio may be at most 1:B, wherein B is 9; 8; 7; 6; 5; 4; 3.9; 3.8; 3.7; 3.6; 3.5; 3.4; 3.3; 3.2; 3.1; 3.0; 2.9; 2.8; 2.7; 2.5; 2.45; 2.40; 2.35; 2.30; 2.25; 2.20; 2.15; 2.10; 2.05; 2.00; 1.9; 1.8; 1.7; 1.6; 1.5; 1.4; 1.3; 1.2; 1.1; or 1.

The use of such exemplary mixtures in the methods described herein may result in the formation of pastes having the advantages disclosed herein.

The polyol(s) included in the mixture may be any of the polyols described herein. In particular, the polyol(s) may comprise or consist of xylitol.

The vegetable(s) included in the mixture may be any of the vegetables described herein. In particular, the vegetable(s) may comprise or consist of swede.

The edible mixture may further include flavourings described above, optionally present as other edible constituents, in amounts of less than 1 wt %; 0.1 wt %; 0.01 wt %; or 0.001 wt %.

The edible mixtures may be used in a described method to form edible pastes.

### Pastes

There is also provided a paste obtainable by a described method and/or use.

There is also provided an edible paste consisting of from 14 wt % to 92 wt % water; from 6 wt % to 39 wt % polyol(s); from 2 wt % to 30 wt % vegetable derived solids; and from 0 wt % to 20 wt % other edible constituents, wherein the vegetable derived solids:polyol(s) ratio is from 1:1.25 to 1:20.

The vegetable derived solids:polyol ratio of the paste may be from 1.25:1 to 1:3; and/or from 1:1.5 to 1:2.5.

By “vegetable derived solids” it is meant the mass of vegetables excluding water contained within the vegetables. Therefore, for example, if 1.0 kg of swedes and 200 g of xylitol are included in a mixture, the swedes used are known to be 90 wt % water (which can be readily determined by routine nutritional analysis or by look up in known data tables), the mixture includes 100 g of swede (vegetable) derived solids and, therefore, the ratio of vegetable derived solids:polyol of the mixture would be 1:2.0. Similarly, it is expected that the mass of solids would not vary as a result of the method (principally only the mass of water will change due to evaporation and or boiling), therefore, the vegetable derived solids:polyol ratio of the paste would also be 1:2.0.

The vegetable derived solids:polyol ratio may be at least 1:A, wherein A is 1.25; 1.30; 1.35; 1.40; 1.45; 1.50; 1.55; 1.60; 1.65; 1.70; 1.75; 1.80; 1.85; 1.90; 1.95; 2.0; 2.1; 2.2; 2.3; 2.4; 2.5; 2.6; 2.7; 2.8; 2.9; 3.0; 3.5; 4.0; 4.5; 5.0; 5.5; 6.0; 6.5; 7.0; 8.0; 9; 10; 11; 12; 13; 14; 15; 16; 17; 18; 19; or 20.

The vegetable derived solids:polyol ratio may be 1:2.0; 1:2; about 1:2.0; or about 1:2.

The vegetable derived solids:polyol ratio may be at most 1:B, wherein B is 20; 19; 18; 17; 16; 15; 14; 13; 12; 11; 10; 9; 8; 7; 6; 5; 4; 3.9; 3.8; 3.7; 3.6; 3.5; 3.4; 3.3; 3.2; 3.1; 3.0; 2.9; 2.8; 2.7; 2.5; 2.45; 2.40; 2.35; 2.30; 2.25; 2.20; 2.15; 2.10; 2.05; 2.00; 1.9; 1.8; 1.7; 1.6; 1.5; 1.4; 1.3 or 1.25.

The water may be present in an amount of at least 14 wt %; 20 wt %; 30 wt %; 40 wt %; 45 wt %; 50 wt %; 55 wt %; 60 wt %; 65 wt %; 70 wt %; 75 wt %; 80 wt %; 85 wt %; 90 wt %; or 92 wt %.

The water may be present in an amount of at most 92 wt %; 90 wt %; 85 wt %; 80 wt %; 75 wt %; 70 wt %; 65 wt %; 60 wt %; 55 wt %; or 50 wt %.

In particular, the water may be present in an amount of from 50 wt % to 90 wt %.

The polyols may be present in an amount of at least 6 wt %; 7 wt %; 8 wt %; 9 wt %; 10 wt %; 11 wt %; 12 wt %; 14 wt %; 16 wt %; 18 wt %; 20 wt %; 22 wt %; 24 wt %; 26 wt %; 28 wt %; 30 wt %; 32 wt %; 35 wt %; or 39 wt %.

The polyols may be present in an amount of at most 39 wt %; 37 wt %; 35 wt %; 33 wt %; 31 wt %; 29 wt %; 27 wt %; 25 wt %; 23 wt %; 21 wt %; 19 wt %; 18 wt %; 17 wt %; 16 wt %; 15 wt %; 14 wt %; 13 wt %; 12 wt %; 11 wt %; 10 wt %; or 9 wt %.

In particular, the polyol(s) may be present in an amount of from 9 wt % to 32 wt % or from 9 wt % to 17 wt %.

The vegetable derived solids may be present in an amount of at least 2 wt %; 3 wt %; 4 wt %; 5 wt %; 6 wt %; 7 wt %; 8 wt %; 9 wt %; 10 wt %; 12 wt %; 14 wt %; 15 wt %; or 16 wt %.

The vegetable derived solids may be present in an amount of at most 30 wt %; 28 wt %; 26 wt %; 24 wt %; 22 wt %; 20 wt %; 18 wt %; 17 wt %; 16 wt %; 15 wt %; 14 wt %; 13 wt %; 12 wt %; 11 wt %; 10 wt %; 9 wt %; 8 wt %; 7 wt %; 6 wt %; 5 wt %; 4 wt %; 3 wt %.

In particular, the vegetable derived solids may be present in an amount of from 4 wt % to 16 wt % or from 4 wt % to 10 wt % or from 4 wt % to 6 wt %.

Other edible constituents may be present in an amount of at most 20 wt; 15 wt %; 10 wt %; 9 wt %; 8 wt %; 7 wt %; 6 wt %; 5 wt %; 4 wt %; 3 wt %; 2 wt %; 1 wt %; 0.5 wt %; present in only trace amounts or not present.

In particular, the other edible constituents may be present in an amount of from 0 wt % to 4 wt % or 0 wt % to 1 wt %.

Providing a paste low in other edible constituents may be advantageous in that the paste may be perceived as healthy.

The paste may comprise 7 wt % or less sugars. The paste may comprise 6 wt %; 5 wt %; 4 wt %; 3 wt %; 2 wt %; 1 wt %; or no sugars. Providing a paste low in sugars reduces the GI of the paste and may be advantageous, as described herein. The sugars that are present may originate from the vegetable(s) included in the mixture. The sugar content may be increased by adding sugars and/or varied by changing the vegetable(s) chosen.

The polyol(s) included in the mixture may be any of the polyols described herein. In particular, the polyol(s) may comprise or consist of xylitol.

The vegetable(s) included in the mixture may be any of the vegetables described herein. In particular, the vegetable(s) may comprise or consist of swede.

As will be apparent, due to heating the mixture for a sufficient temperature and a sufficient period, the paste may be described as “cooked”. Accordingly, the pastes may be described as containing vegetable derived solids and polyol(s) which have been cooked together.

The pastes described herein have naturally long shelf lives without the addition of preservatives. For example, the pastes may have shelf lives in excess of six weeks in a sterilised jar in a refrigerator, or longer.

As will be apparent, the paste may have any of the features which result from the described methods and or use of the described mixtures.

### Dehydration of Paste

There is also provided a composition obtainable by dehydrating an above described paste.

There is also provided a method of producing a composition comprising dehydrating an above described paste.

There is also provided an edible composition consisting of: from 7 wt % to 50 wt % water; from 12 wt % to 67 wt % polyol(s); from 4 wt % to 52 wt % vegetable derived solids; and from 0 wt % to 40 wt % other edible constituents, wherein the vegetable derived solids:polyol(s) ratio is from 1:1.25 to 1:20.

The vegetable derived solids:polyol ratio of the composition may be from 1.25:1 to 1:3; and/or from 1:1.5 to 1:2.5.

In a similar way to that explained above in respect of the described paste, it is expected that the mass of solids would not vary as a result of dehydrating the paste (principally only the mass of water will change due to dehydration), therefore, the vegetable derived solids:polyol ratio of the composition is expected to be that of the paste from which it is derived.

The vegetable derived solids:polyol ratio may be at least 1:A, wherein A is 1.25; 1.30; 1.35; 1.40; 1.45; 1.50; 1.55; 1.60; 1.65; 1.70; 1.75; 1.80; 1.85; 1.90; 1.95; 2.0; 2.1; 2.2; 2.3; 2.4; 2.5; 2.6; 2.7; 2.8; 2.9; 3.0; 3.5; 4.0; 4.5; 5.0; 5.5; 6.0; 6.5; 7.0; 8.0; 9; 10; 11; 12; 13; 14; 15; 16; 17; 18; 19; or 20.

The vegetable derived solids:polyol ratio may be 1:2.0; 1:2; about 1:2.0; or about 1:2.

The vegetable derived solids:polyol ratio may be at most 1:B, wherein B is 20; 19; 18; 17; 16; 15; 14; 13; 12; 11; 10; 9; 8; 7; 6; 5; 4; 3.9; 3.8; 3.7; 3.6; 3.5; 3.4; 3.3; 3.2; 3.1; 3.0; 2.9; 2.8; 2.7; 2.5; 2.45; 2.40; 2.35; 2.30; 2.25; 2.20; 2.15; 2.10; 2.05; 2.00; 1.9; 1.8; 1.7; 1.6; 1.5; 1.4; 1.3 or 1.25.

The water may be present in an amount of at least 7 wt %; 10 wt %; 15 wt %; 20 wt %; 25 wt %; 30 wt %; 35 wt %; 40 wt %; 45 wt %, or 50 wt %.

The water may be present in an amount of at most 50 wt %; 45 wt %; 40 wt %; 35 wt %; 30 wt %; 25 wt %; 20 wt %; 15 wt %; 10 wt % or 7 wt %.

The polyols may be present in an amount of at least 12 wt %; 14 wt %; 16 wt %; 18 wt %; 20 wt %; 22 wt %; 24 wt %; 26 wt %; 28 wt %, 32 wt %; 36 wt %; 40 wt %; 44 wt %; 48 wt %; 52 wt %; 56 wt %; 60 wt %; 64 wt % or 67 wt %.

The polyols may be present in an amount of at most 67 wt %; 64 wt %; 60 wt %; 56 wt %; 52 wt %; 48 wt %; 44 wt %; 40 wt %; 36 wt %; 32 wt %; 28 wt %; 26 wt %; 24 wt %; 22 wt %; 20 wt %; 18 wt %; 16 wt %; 14 wt %; or 12 wt %.

The vegetable derived solids may be present in an amount of at least 4 wt %; 6 wt %; 8 wt %; 10 wt %; 12 wt %; 14 wt %; 16 wt %; 18 wt %; 20 wt %; 24 wt %; 28 wt %; 30 wt %; 35 wt %; 40 wt %; 45 wt %; 50 wt %; or 52 wt %.

The vegetable derived solids may be present in an amount of at most 52 wt %; 48 wt %; 44 wt %; 40 wt %; 36 wt %; 32 wt %; 28 wt %; 24 wt %; 20 wt %; 16 wt %; 12 wt %; 8 wt %; or 4 wt %.

Other edible constituents may be present in an amount of at most 40 wt %; 30 wt %; 20 wt %; 18 wt %; 16 wt %; 14 wt %; 12 wt %; 10 wt %; 8 wt %; 6 wt %; 4 wt %; 2 wt %; 1 wt % or 0.5 wt %; present in only trace amounts or not present.

In particular, the other edible constituents may be present in an amount of from 0 wt % to 8 wt % or 0 wt % to 2 wt %.

Providing a composition low in other edible constituents may be advantageous in that the composition may be perceived as healthy.

The composition may comprise 14 wt % or less sugars. The paste may comprise 7 wt %; 10 wt %; 8 wt %; 6 wt %; 4 wt %; 2 wt %; 1 wt %; or no sugars. Providing a composition low in sugars may be advantageous for similar reasons as those given in respect of the paste above.

The polyol(s) included in the mixture may be any of the polyols described herein. In particular, the polyol(s) may comprise or consist of xylitol.

The vegetable(s) included in the mixture may be any of the vegetables described herein. In particular, the vegetable(s) may comprise or consist of swede.

As will be apparent, due to heating the mixture for a sufficient temperature and a sufficient period, the composition may be described as “cooked”. Accordingly, the compositions may be described as containing vegetable derived solids and polyol(s) which have been cooked together.

The compositions described herein have naturally long shelf lives without the addition of preservatives. For example, the compositions may have shelf lives in excess of six weeks in a sterilised jar in a refrigerator, or longer.

The compositions, because they have lower masses than the pastes from which they are derived, may be easier to transport.

The compositions may be rehydrated by the addition of water (with optional heating) to provide the pastes described above.

The compositions may be used directly in the production of a food product. Accordingly, there is also provided a food product including a described composition. The food products may be any of those described below with reference to the paste. In the production of such food products it will be necessary to ensure that required water is present, for example by adding water or egg to the recipes used to produce such food products.

The compositions may be obtained by dehydrating the pastes described above using known dehydration techniques. For example, spray drying may be used to obtain the compositions from the described pastes (this method may be carried out by heating a stainless steel funnel, e.g. to about 200+° C., spraying the paste from the top of the funnel such that it touches the side of the funnel, and dries rapidly resulting in a spray dried powder. Other alternative known dehydration techniques may be used.

As will be apparent, the compositions may have any of the features which result from the described pastes, methods and/or use of the described mixtures.

### Uses of Pastes

The pastes may be used in the production of a food product.

Accordingly, there is also provided a food product including a described paste.

Further, the paste may be used as a sugar substitute. Yet further, the paste may be used as an egg substitute, a fat substitute, and/or an oil substitute.

The food product may be a baked good, e.g. a cake or a brownie, a chocolate mousse, a chocolate torte, a spread, e.g. a hazelnut coca spread (similar to that sold under the NUTELLA™ brand), an ice cream, a sauce (e.g. caramel flavoured sauce).

As will be apparent, the paste therefore enables the provision of sugar free deserts. E.g. deserts containing less than 5 wt %; 4 wt %; 3 wt %; 2 wt %; or 1 wt % sugar. Which is particularly advantageous for those on diets desiring or requiring low sugar intake.

The paste can also be used as a butter, sugar & egg replacement in the production of desserts. Alternatively, the paste may be used alongside butter, sugar and/or egg in the production of food products.

When the paste is used as a sugar substitute, it may be desired to substitute only a portion of the sugar in a recipe. This may be desirable where consumers do not desire, or have a negative perception of, sugar free products. Accordingly, the paste may be used alongside sugar in the production of food products.

In particular, using the present paste it is possible to prepare cakes which do not require sugar and/or oils in their production. Such cakes are advantageous for those having a diet which desires or requires avoidance of sugar and/or oils.

In particular, it is possible to produce cakes which are sugar free and for which consumers cannot tell the difference between the produced cake and their sugar containing equivalent. This has been demonstrated with blind trials.

### EXAMPLES

### Example 1

1 kg (45.4 wt %) of peeled and diced (approx. 2.5 cm cubes) swede, 200 g (9.1 wt %) of xylitol, 1 fresh chopped (approx. 1 cm strips) vanilla pod (approx. 1 g, approx. 0.05 wt %), and 1 L (1 kg, 45.4 wt %) of water were combined in a pan.

As will be apparent, this example mixture has a composition of 45.4 wt % water; 45.4 wt % vegetable(s); and 9.1 wt % polyol(s), and a vegetable:polyol ratio of 1:0.20.

The resultant mixture was then brought to the boil. The mixture was brought to the boil in a domestic cooking pan on a domestic stove with the lid on. The mixture was then heated at boiling for 30 minutes with the lid on. Subsequently, the lid was removed from the pan and the mixture simmered for 90 minutes. This yielded a paste having a mass of 1.7 kg.

The paste was subjected to Nutritional Testing by The International Centre for Nutritional Excellence Limited and the results are shown in Table 1.

TABLE 1

| Test | Method used | Result | |
|---|---|---|---|
| Moisture | AM/C/1015 | 83.0 | wt % |
| Total Carbohydrate (by difference) | AM/C/901 | 13.4 | wt % |
| Total Dietary Fibre | AM/C/309 | 1.3 | wt % |
| Available Carbohydrate (by difference) | AM/C/901 | 12.1 | wt % |
| Total Sugar | AM/C/1014 | 4.0 | wt % |
| Total Fat | AM/C/1015 | 2.8 | wt % |
| Saturated Fatty Acids (in sample) | AM/C/107 | 0.69 | wt % |
| Monosaturated Fatty Acids (in sample) | AM/C/107 | 0.66 | wt % |
| Polyunsaturated Fatty Acids (in sample) | AM/C/107 | 1.32 | wt % |
| Protein | AM/C/224 | 0.45 | wt % |
| Ash | AM/C/803 | 0.4 | wt % |
| Sodium (ICP-OES) | AM/C/1002 | 0.00393 | wt % |
| Sodium (expressed as salt) | AM/C/1002 | <0.01 | wt % |
| Vitamin B6 (as Pyridoxine) | AM/V/752 | <0.000020 | wt % |
| Vitamin C (as Ascorbic Acid) | AM/V/710 | 0.00752 | wt % |
| Vitamin E (as DL a-tocopherol acetate) | AM/V/702 | <0.000200 | wt % |
| Vitamin K1 (Phylloquinone) | SUB-CON | 0.0000019 | wt % |

| | | |
|---|---|---|
| Energy | AM/C/901 | 78 kcal/100 g |
| Energy | AM/C/901 | 327 kJ/100 g |

Since the 1700 g paste comprises 83.0 wt % water (1411 g) and 200 g of xylitol (11.8 wt %), by subtracting the mass of the water and xylitol from the total and assuming the mass of the vanilla beans from the pod to be negligible, it has been calculated that the paste comprises 89 g (5.2 wt %) vegetable derived solids.

Accordingly, the example paste comprises water 83.0 wt %; xylitol 11.8 wt %; swede derived solids 5.2 wt %.

As can be seen from table 1, the paste only comprises 4.0 wt % sugar.

This paste is a particularly preferred example. The paste was smooth and velvety. It has been used successfully in multiple recipes. Minimal (if any) extra sweetness is required to be added to recipes including this paste.

### Example 2

1 kg (45.4 wt %) of peeled and diced (approx. 2.5 cm cubes) swede, 200 g (9.1 wt %) of xylitol, 1 fresh chopped (approx. 1 cm strips) vanilla pod (approx. 1 g, approx. 0.05 wt %), and 1 L (1 kg, 45.4 wt %) of water were combined in a pan.

As will be apparent, this example mixture has a composition of 45.4 wt % water; 45.4 wt % vegetable(s); and 9.1 wt % polyol(s), and a vegetable:polyol ratio of 1:0.20.

The resultant mixture was then brought to the boil. The mixture was brought to the boil in a domestic cooking pan on a domestic stove with the lid on. The mixture was then heated at boiling for 30 minutes with the lid on. Subsequently, the lid was removed from the pan and the mixture simmered for 45 minutes. This yielded a paste having a mass of 1.7 kg.

This paste has been used successfully in recipes and appears to be best option with minimal extra sweetness required.

By assuming that no solids are lost during the cooking process and the mass of the vanilla beans to be negligible (and knowing that swede is known to comprise 90 wt % water), this paste has been calculated to have the following composition. 100 g (10 wt % of 1 kg) swede derived solids, 200 g xylitol, 1400 g water. Accordingly, this paste has been calculated to comprise water 82.4 wt %, xylitol 11.8 wt %, and swede derived solids 5.9 wt %.

### Example 3

1 kg (37.0 wt %) of peeled and diced (approx. 2.5 cm cubes) swede, 200 g (7.4 wt %) of xylitol, 1 fresh chopped (approx. 1 cm strips) vanilla pod (approx. 1 g, approx. 0.05 wt %), and 1.5 L (1.5 kg, 55.5 wt %) of water were combined in a pan.

As will be apparent, this example mixture has a composition of 55.5 wt % water; 37.0 wt % vegetable(s); and 7.4 wt % polyol(s), and a vegetable:polyol ratio of 1:0.20.

The resultant mixture was then brought to the boil. The mixture was brought to the boil in a domestic cooking pan on a domestic stove with the lid on. The mixture was then heated at boiling for 30 minutes with the lid on. Subsequently, the lid was removed from the pan and the mixture simmered for 60 minutes. This yielded a paste having a mass of 2.2 kg.

This paste has been used successfully in recipes. However, the additional sweetness of examples 1 and 2 may be preferred by some palates.

By assuming that no solids are lost during the cooking process and the mass of the vanilla beans to be negligible (and knowing that swede is known to comprise 90 wt % water), this paste has been calculated to have the following composition. 100 g (10 wt % of 1 kg) swede derived solids, 200 g xylitol, 1900 g water. Accordingly, this paste has been calculated to comprise water 86.4 wt %, xylitol 9.1 wt %, and swede derived solids 4.5 wt %.

### Example 4

1 kg (58.8 wt %) of peeled and diced (approx. 2.5 cm cubes) swede, 200 g (11.8 wt %) of xylitol, 1 fresh chopped (approx. 1 cm strips) vanilla pod (approx. 1 g, approx. 0.05 wt %), and 0.5 L (0.5 kg, 29.4 wt %) of water were combined in a pan.

As will be apparent, this example mixture has a composition of 29.4 wt % water; 58.8 wt % vegetable(s); and 11.8 wt % polyol(s), and a vegetable:polyol ratio of 1:0.20.

The resultant mixture was then brought to the boil. The mixture was brought to the boil in a domestic cooking pan on a domestic stove with the lid on. The mixture was then heated at boiling for 30 minutes with the lid on. Subsequently, the lid was removed from the pan and the mixture simmered for 35 minutes. This yielded a paste having a mass of 640 g.

This paste has been used successfully in recipes. However, some palates may prefer a less intense sweetness. Further, some recipes may require additional water when this paste is used.

By assuming that no solids are lost during the cooking process and the mass of the vanilla beans to be negligible (and knowing that swede is known to comprise 90 wt % water), this paste has been calculated to have the following composition. 100 g (10 wt % of 1 kg) swede derived solids, 200 g xylitol, 340 g water. Accordingly, this paste has been calculated to comprise water 53.1 wt %, xylitol 31.3 wt %, and swede derived solids 15.6 wt %.

### Example 5

1 kg (45.4 wt %) of peeled and diced (approx. 2.5 cm cubes) carrots, 200 g (9.1 wt %) of xylitol, 1 fresh chopped (approx. 1 cm strips) vanilla pod (approx. 1 g, approx. 0.05 wt %), and 1 L (1 kg, 45.4 wt %) of water were combined in a pan.

As will be apparent, this example mixture has a composition of 45.4 wt % water, 45.4 wt % vegetable(s), 9.1 wt % polyol(s), and a vegetable:polyol ratio of 1:0.20.

The resultant mixture was then brought to the boil. The mixture was brought to the boil in a domestic cooking pan on a domestic stove with the lid on. Subsequently, the lid was removed from the pan and the mixture simmered for 120 minutes. This yielded a paste having a mass of 950 g.

This paste has been used successfully in recipes. However, some palates may prefer the blander taste of the examples above using swede. Further, the paste was orange/brown in colour and the colourless appearance of the swede examples may be preferred.

By assuming that no solids are lost during the cooking process and the mass of the vanilla beans to be negligible (and knowing that carrot is known to comprise 90 wt % water), this paste has been calculated to have the following composition. 100 g (10 wt % of 1 kg) carrot derived solids, 200 g xylitol, 650 g water. Accordingly, this paste has been calculated to comprise water 68.4 wt %, xylitol 21.0 wt %, and carrot derived solids 10.5 wt %.

### Example 6

1 kg (38.5 wt %) of peeled and diced (approx. 2.5 cm cubes) parsnips, 600 g (23.1 wt %) of xylitol, and 1 L (1 kg, 38.5 wt %) of water were combined in a pan.

As will be apparent, this example mixture has a composition of 38.5 wt % water; 38.5 wt % vegetable(s); and 23.1 wt % polyol(s), and a vegetable:polyol ratio of 1:0.6.

The resultant mixture was then brought to a slow boil. The mixture was brought to the boil in a domestic cooking pan on a domestic stove with the lid on. The mixture was then heated at a slow boil for 30 minutes with the lid on. Subsequently, the lid was removed from the pan and the mixture simmered for 45 minutes. This yielded a paste having a mass of 2.1 kg.

This paste has been used successfully in recipes.

By assuming that no solids are lost during the cooking process (and knowing that parsnip is known to comprise 80 wt % water), this paste has been calculated to have the following composition. 200 g (20 wt % of 1 kg) parsnip derived solids, 600 g xylitol, 1,300 g water. Accordingly, this paste has been calculated to comprise water 61.9 wt %, xylitol 28.6 wt %, and parsnip derived solids 9.5 wt %.

### OTHER EXAMPLES

In other examples different root vegetables were used. For example, carrots, turnips, and parsnips were variously used to advantage.

By experimentation it has been found that low starch vegetables preferred. For example, potatoes have also been used in examples; however, these may not be favoured as they are relatively high in starch. For example, when using such a paste in baking it has been found that the starch may react deleteriously with flour and/or an undesirable starchy flavour may be present in baked food products.

### Example Composition by Dehydration of Paste

300 g of the paste from example 6 was heated to 80° C., then stirred till cool enough to handle, the paste was then spread as thinly as possible onto a perforated plastic mesh with a palette knife. The perforated plastic mesh and paste were then placed into a dehydration box held at 140° C. for 36 hrs. This yielded of 66 g of dehydrated paste as an edible composition. Some of the composition was of a powdery consistency and some was of a tough leather consistency. It is thought that this composition has the vegetable derived solids:polyol ratio of the paste from which it is derived, i.e. 1:3.0. It is also thought that some paste and/or dehydrated paste is lost in the dehydration process, for example because it was not removed from the perforated plastic mesh.

This composition was rehydrated by addition of water and optional warming. The paste formed by such rehydration was used in examples described below.

### Example Use of Paste—Caramel Flavoured Sauce

It is also possible to make a caramel flavoured sauce including the paste:

1kg of parsnips are blackened in a heavy bottom pan by cooking in rape seed oil. 2 vanilla pods, 100 g of the paste from above, 11 water, 400 mL coconut milk are added and the mixture simmered for 2 to 3 hrs with the lid on. The mixture is filtered through a muslin cloth to provide a caramel flavoured sauce.

Optionally, if desired, the sauce may be further thickened by additional simmering.

Additionally or alternatively, if desired, the sauce may be further thickened with tapioca flour.

### Example Use of Paste—Cakes

Lemon Cake

4 oz (113 g) of an above described paste, ½ oz (14 g) polyol, 30 ml oil, 30 ml lemon juice were combined in a bowl. 4 oz flour and 1 is baking powder were sifted into the bowl and the resultant mixture combined to form a cake batter. The batter was cooked in a usual way for 25 to 35 minutes in a 180° C. oven to form a cake.

Orange Cake

200 g of an above described paste, 30 ml orange puree, the zest & juice of two oranges, 60 ml oil, and 80 ml water were combined in a bowl. 100 g Ground almonds, 100 g Flour, and 2 tsp baking powder were sifted into the bowl and the resultant mixture combined to form a cake batter. The batter was cooked in a usual way for 25 to 35 minutes in a 180° C. oven to form a cake.

Chocolate Cake

200 g of an above described paste, 80 ml water, 60 g oil, 50 g chocolate (sugar free), 10 g Cacao, 20 g Polyol, and ½ tsp salt were combined in a bowl. 200 g flour was sifted into the bowl and the resultant mixture combined to form a cake batter. The batter was cooked in a usual way for 25 to 35 minutes in a 180° C. oven to form a cake.

Victoria Sponge Cake

180 g of an above described paste, 50 g polyol, 60 ml Oil, 180 ml water, and 20 ml vanilla water were combined in a bowl. 200 g flour was sifted into the bowl and the resultant mixture combined to form a cake batter. The batter was cooked in a usual way for 25 to 35 minutes in a 180° C. oven to form a cake.

Chocolate Brownie

150 g of an above described paste, 120 g chocolate (sugar free), 50 g cacao, 50 g polyol, 30 ml oil, 50 ml coconut milk, and ½ tsp salt were combined in a bowl. 150 g flour and 1 tsp baking powder were sifted into the bowl and the resultant mixture combined to form a brownie batter. The batter was cooked in a usual way for 25 to 35 minutes in a 180° C. oven to form a brownie.

Coffee And Walnut Cake

100 g of an above described paste, 10 g cacao, 30 ml oil, 60 ml coconut milk, 50 g polyol, 2 tsp coffee powder were combined in a bowl. 100 g ground walnut, 100 g flour, and 2 tsp baking powder were sifted into the bowl and the resultant mixture combined to form a cake batter. The batter was cooked in a usual way for 25 to 35 minutes in a 180° C. oven to form a cake.

Chocolate Muffins

40 g water, 50 g oil, 100 g of an above described paste, and 60 g egg were mixed together. 100 g FF flour, 20 g cacao powder, 7 g whey powder, 0.5 g bicarb, 2.5 g bake powder, 20 g sweetener, 5 g glucose were sieved together. The two mixtures were folded together. The folded mixture was divided between muffin cases and cooked for 35 minutes in a 165° C. oven to form muffins.

In this chocolate muffin recipe it has been found that sugar can be swapped like for like with the above described paste.

Fruit Sponge Cake

54 g butter, 160 g of an above described paste, and 40 g sugar were creamed together. Subsequently 10 g bake powder, 2.5 g tartaric, 15 g whey powder, 10 g glucose, 50 g glycerine, and 260 g cake flour were folded in to the mixture. Then 120 g egg, 50 g oil, 95 ml water, and 100 g sultanas were mixed in. The mixture was cooked for 30 minutes in a 170° C. oven to form a fruit sponge.

Mini Roll

4 tsp boiling water was mixed with 20 g cacao powder. 120 g of an above described paste and 30 g butter was mixed in, followed by 40 g of plain flour. Separately the yokes from 4 eggs were beaten and 20 g of an above described paste added, the cacao mix was folded into the egg mixture. The whites from 4 eggs were beaten and folded into the resultant mixture. The mixture was cooked for 12 to 18 minutes in a 170° C. oven to form a mini roll base.

Mini Roll Filling

100 g butter, 150 g of an above described paste, 75 g icing sugar, 20 g glycerol, and 5 g vanilla were blended together at high speed until light & creamy.

The mini roll and the mini roll filling may be combined to form a filled mini roll.

Malted Loaf

200 g of mixed dried fruit was soaked in 200 ml of hot black tea for 3 hrs. The resultant was mixed with 80 mL malt extract, 60 g of an above described paste, 60 g prune puree, 30 g egg. Subsequently 250 g plain flour, 5 g bake powder, and 2 g bicarb were folded in. The mixture was cooked for 40 to 50 minutes in a 150° C. oven to form a malted loaf.

Doughnut Mix

200 g strong flour, 20 g fine flour, 5 g bicarb, 10 g soya powder, 1 g lecithin powder, 2 g dextrose, 10 g egg yolk powder, 10 g milk powder, and 0.5 g xanthan gum were mixed together. Subsequently, 80 g of an above described paste, 100 g water, 25 g glycerine, and 15 g oil were mixed in. The mixture was allowed to rest for 20 min. The mixture was then shaped into balls and deep fried to form doughnuts.

Madeire Cake

95 g butter and 110 g of an above described paste were creamed together, 120 g was folded in to the creamed mixture, 50 g oil and 10 g glycerine were mixed in, 175 g soft flour and some baking powder was sieved in and the resultant mixed, 2 g of lemon zest was added and mixed. The mixture was then baked for 30 to 40 minutes in a 165° C. oven.

In this madeire cake recipe it has been found that sugar can be swapped like for like with the above described paste.

Orange Cake

60 mL Oil, 30 mL orange puree, the juice of 2 oranges, 80 mL water, and 200 g of an above described paste were mixed together. 100 g ground almond, 100 g self-raising flour, 2.5 g bake powder, and the zest of 2 oranges were folded in. The mixture was then baked for 30 minutes in a 170° C. oven.

In this orange cake recipe it has been found that sugar can be swapped like for like with the above described paste.

In each of the above cake recipes, it was found that use of carbonated water in place of regular water (where used) can increase the aeration and lightness of the resultant cake.

### Example Use of Paste—Chocolate Torte

A dark chocolate mousse was prepared by combining 300 g of an above described paste, 450 g 75% cacao chocolate (sugar free), and 400 g coconut milk. The mousse was set in a refrigerator.

In a similar way, a milk chocolate mousse was prepared by combining 400 g of an above described paste, 350 g 65% cacao chocolate (sugar free), and 400 g coconut milk. The mousse was set in a refrigerator.

A torte base was prepared by combing 6 oz (170 g) of an above described paste, 3 oz (85 g) 75% cacao chocolate (sugar free), 5 oz (142 g) flour, ½ oz (14 g) cacao, 1 oz (28 g) polyol, 1 oz (28 g) coconut milk, 30 ml oil, ½ tsp salt and 2 tsp baking powder.

Finally, a torte was formed by layering the torte base and chocolate mousses.

### Example Use of Paste—Ice Cream

A chocolate ice cream was prepared using the following method. Boil coconut milk (300 ml full-fat coconut milk or coconut cream—thicker cream is preferred) with vanilla seeds (from ½ vanilla pod) & thicken with tapioca flour (½ tsp mixed with a little water), add an above described paste (200 ml), cocoa powder (20 g unsweetened) & warm till dissolved. Melt in chocolate (100 g dark chocolate (sugar free)) with salt (¼ tsp salt) & cool for 1 hr. Blend in a blender for 1 minute and freeze.

### Example Use of Paste—Coca Spread

200 ml soy milk, 200 g nuts, 400 ml water, 200 ml coconut milk, 4 tsp vanilla, 400 g of an above described paste, 60 g cacao, 100 g polyol, and 100 g 75% chocolate (sugar free) were combined, cooked for 40 minutes, and blended in a food processor to form a coca spread.

### Example Use of Paste—Fudge

400 g of an above described paste, 150 g butter, 200 g cream, 200 g coconut milk, and 200 g sugar were combined in a pan and heated to soft ball temperature (235-245° F., 113-118° C.). The fudge mixture was then poured onto a prepared surface and allowed to cool.

### Example Use of Paste—Jelly Beans

150 ML fruit juice, 300 ml of an above described paste, 150 g sugar, 50 g glucose, optional food colouring, and 1 g of citric acid were combined in a pan and heated to 100° C. 50 g pectin was added. The mixture was then heated to soft ball temperature (235-245° F., 113-118° C.). The jelly bean mixture was then poured onto a prepared surface and allowed to cool.

### Example Use of Paste—Chocolate

100 g of an above described paste was heated to around 120° C. to remove excess moister, then 150 g cacao butter, 15 g cacao Powder, 60 g milk powder, 20 ml glycerol, 20 ml glucose, and 100 g sugar were added and after mixing were allowed to cool to form a chocolate. Although a concher has not been used to date, it is thought that use of a concher would result in superior results.

Nougat

200 g sugar, 40 mL water, and 50 g glucose were added to a pan and heated to 140° C. 200 g of an above described paste was added and the mixture heated to 250° F. (121° C.). This mixture was added to a beaten mixture of 2 egg whites and 1 & ½ teaspoons tatar. Subsequently, the resultant mixture was allowed to cool.

Fruit Pastilles

100 ml Fruit juice, 500 mL of an above described paste, 500 g sugar, 300 g water, 335 g glucose, optional food colouring, and 1½ tsp Citric acid were added to a pan and heated to 100° C. and 8 g gelatine was added. The mixture was further heated to soft ball temperature (235-245° F., 113-118° C.). The fruit pastille mixture was then poured onto a prepared surface and allowed to cool.

Toffee

200 g of an above described paste, 200 g sugar, 200 g milk (soya milk or oat milk may be used), 60 g glucose, and 80 g cacao butter were combined and heated to 160° C. and subsequently poured onto a prepared surface and allowed to cool.

### Example Use of Paste—Biscuits

Custard Creams

40 g of an above described paste and 80 g butter were creamed together. 10 g dextrose, 200 g cake flour, 30 g custard powder, 10 g vanilla essence, and 5 g oil were added and the mixture formed into a smooth ball. The mixture was then chilled, rolled, and cut to biscuit shapes. The cut pieces were then baked in a 160° C. oven.

Bourbon Biscuits

1.5 oz (43 g) plain flour, 1.5 oz (43 g) oat flour, 1 oz (28 g) corn flour, 0.5 oz (14 g) cacao, 2 oz (57 g) cacao butter, 2 oz (57 g) of an above described paste, 2.5 oz (71 g) glycerine, and ¼ of an egg were mixed together to form a smooth ball, chilled, rolled, cut, and cooked in a 160° C. oven to form a bourbon biscuit.

Digestive/Oatie Biscuit

160 g of an oat & plain flour mix, 60 g tapioca flour, 20 g milk powder, 40 g of an above described paste, 10 g dextrose, 20 g butter, 20 mL glycerine, and 1.4 of an egg were mixed together to form a smooth ball, chilled, rolled, cut, and cooked in a 160° C. oven to form a digestive/oatie biscuit.

Sweet Pastry

40 g of an above described paste, 4 g dextrose, and 20 g water were mixed together. 150 g softened butter, 275 g pastry flour, and 2 g salt were added and mixed to form a sweet pastry.

Biscuit Fondant Filling

100 g butter, 100 g of an above described paste, 20 g dextrose, and 5 g optional flavouring were creamed together and then chilled to for a biscuit fondant filling.

### Example Use of Paste—Preserves

Lemon/Orange Curd

400 g of an above described paste, 160 g of butter, and 180 g of sugar were creamed together. 80 g lemon or orange puree, as appropriate, 28 g pectin, and 300 g egg were mixed in and the mixture cooked to 85° C.

Jam

500 g fruit, 400 g of an above described paste, 3 g citric acid, 200 g sugar, 200 g water, 7 g pectin were place in sugar boiler and cooked to 115° C. to form a jam.

Marmalade

1 kg oranges, lemons, and/or limes, as desired, 1 kg of an above described paste, 500 g sugar, 50 g fruit puree, and 8 g pectin were placed in a sugar boiler & cooked to 115° C. to form a marmalade.

As will be apparent, the above examples demonstrate that a wide variety of food products can be prepared using the described paste.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

1. An edible paste consisting of:
from 14 wt % to 92 wt % water;
from 6 wt % to 39 wt % polyol(s);
from 2 wt % to 30 wt % vegetable derived solids; and
from 0 wt % to 20 wt % other edible constituents,
wherein the vegetable derived solids:polyol(s) ratio is from 1:1.25 to 1:20.

2. The edible paste of claim 1, wherein the paste is homogeneous.

3. The edible paste of claim 1 or 2, wherein the polyol(s) comprises or consists of xylitol.

4. The edible paste of any of claims 1 to 3, wherein the vegetable derived solids comprises or consists of swede derived solids.

5. The edible paste of any of claims 1 to 4, wherein the other edible constituents are present in an amount of from 0 wt % to 4 wt %.

6. The edible paste of claim 5, wherein the other edible constituents are present in an amount of from 0 wt % to 1 wt %.

7. The edible paste of any of claims 1 to 16, wherein the paste comprises 7 wt % or less sugars.

8. A method of preparing an edible paste comprising:
mixing water; polyol(s), and vegetable(s), to form a mixture;
heating the mixture at a sufficient temperature and for a sufficient period of time to form a paste.

9. The method of claim 8, wherein the period of time is at least 32 minutes.

10. The method of claim 8 or 9, wherein the temperature is a temperature sufficient to simmer and/or boil the mixture.

11. The method of any of claims 8 to 10, wherein the polyol(s) comprises or consists of xylitol.

12. The method of any of claims 8 to 11, wherein the vegetable(s) comprises or consists of swede.

13. The method of any of claims 8 to 12, wherein the vegetable:polyol ratio of the mixture is from 1:0.05 to 1:2.

14. The method of any of claims 8 to 13, wherein:
the vegetables include vegetable derived solids; and
the vegetable derived solids:polyol ratio of the mixture is from 1:1.25 to 1:20.

15. An edible mixture, for use in a method according to any of claims 8 to 14, comprising:
water;
vegetable(s); and
polyol(s),
wherein the vegetable:polyol ratio is from 1:0.20 to 1:0.9.

16. An edible mixture, for use in a method according to any of claims 8 to 14, comprising:
water;
vegetables(s) including vegetable derived solids; and
polyol(s),
wherein the vegetable derived solids:polyol ratio is from 1:1.25 to 1:9.

17. Use of the edible mixture according to claim 15 or 16 in a method to form an edible paste.

18. A paste obtainable by the method according to any of claims 8 to 14 or the use of claim 17.

19. An edible composition consisting of:
from 7 wt % to 50 wt % water;
from 12 wt % to 67 wt % polyol(s);
from 4 wt % to 52 wt % vegetable derived solids; and
from 0 wt % to 40 wt % other edible constituents,
wherein the vegetable derived solids:polyol(s) ratio is from 1:1.25 to 1:20.

20. The edible composition of claim 19, wherein the polyol(s) comprises or consists of xylitol.

21. The edible composition of claim 19 or 20, wherein the vegetable derived solids comprises or consists of swede derived solids.

22. The edible composition of any of claims 19 to 21, wherein the other edible constituents are present in an amount of from 0 wt % to 8 wt %, or wherein the other edible constituents are present in an amount of from 0 wt % to 2 wt %.

23. Use of the paste of any of claim 1 to 7 or 18 as a sugar substitute.

24. Use of the paste of any of claim 1 to 7 or 18 in the production of a food product.

25. A food product including the paste of any of claim 1 to 7 or 18.
